(19) United States
(12) Patent Application Publication
(10) Pub. No.: US 2008/0043430 A1
(43) Pub. Date: Feb. 21, 2008

(54) Vibration-proof mechanism for heat-dissipating device

(75) Inventor: Win-Haw Chen, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/657,890

(22) Filed: Jan. 24, 2007

(30) Foreign Application Priority Data
Aug. 17, 2006 (TW) 095214551

(51) Int. Cl. G06F 1/20

(52) U.S. Cl. 361/687

(57) ABSTRACT

The present invention provides a vibration-proof mechanism for use with a heat-dissipating device installed in a machine unit, for absorbing vibrations caused by the operating heat-dissipating device. The vibration-proof mechanism includes a plurality of elastic components, a partitioning member connected with one side of the heat-dissipating device by the elastic components, and a fixing member connected with the partitioning member by the elastic components so as to be installed on the machine unit, thereby suspending the partitioning member midair to form a double vibration-proof structure for enhancing vibration absorption.

### BACKGROUND OF THE INVENTION

1. Field of the Invention

This invention relates to a vibration-proof mechanism for use with a heat-dissipating device, and more particularly, to a vibration-proof mechanism for reducing vibrations caused the heat-dissipating device in operation.

2. Description of Related Art

In a computer host there are main devices installed by a main board, a CPU, various disk driver, a power supply and the like. The devices which are likely to generate high heat have to be processed appropriately upon heat-dissipation, in order to prevent the devices from overheating to damage.

The conventional way of processing the heat-dissipation in a computer host is directly to install a dissipating fan in the computer case, and hence airflow is formed by the heat-dissipating fan, thereby allowing the hot air in the case to be emitted and cool air to come into the case for heat-dissipation. Yet the heat-dissipating fan is fixed directly by a screw in the case, and that makes direct the contact between the heat-dissipating fan and the computer case. The running heat-dissipating fan will generate vibrations, and thereby making noises. Also the hard disk disposed in the case will be influenced by high-frequency vibrations, which cause that the hard disk's head for reading and writing is damaged by colliding with magnetic tracks when the hard disk is accessing in a high speed operation. Therefore, a vibration-proof measure must be made between the heat-dissipating fan and the case in order to prevent the hard disk from being influenced by the heat-dissipating fan, thereby preventing the hard disk from being damaged.

Taiwanese Patent No. M283493-A vibration-proof structure for use with a heat-dissipating fan is shown in FIG. 1. The vibration-proof structure provides at least one heat-dissipating fan in an electronic apparatus for the use of various heat-dissipating device. On the four corners of the heat-dissipating fan 11 a binding hole 110 is disposed. A vibration-proof component 12 made of a vibration-absorptive material is disposed into the binding hole 110. A fixed binding component 13, e.g. a bolt or a rivet, is then penetrated into the binding hole 110 and disposed on a fixing shelve 14 of the electronic apparatus, and thereby allowing the vibration-proof component 12 to be covered between the binding component 13 and binding hole 110 to achieve vibration-proof effect.

The influence to the hard disk by vibrations can be prevented by means of the vibration-proof component 12 which absorbs the vibration energy caused by operating the heat-dissipating fan 11 and the vibration energy is reduced and transferred to the fixing shelve 14.

Yet the heat-dissipating fan 11 has direct contact with the fixing shelve 14, without any vibration-absorptive measure in between, and thus the effect of vibration-proof is not good and needs to be improved.

Taiwanese Patent No. 269691-An apparatus for installing heat-dissipating fans with a vibration-absorptive structure is shown in FIG. 2. The apparatus includes a fan frame 2 with a flange 21 and a plurality of buffering gaskets 22 disposed on the fan frame 2. The flange 21 is provided with a punching hole 210, and the buffering gasket 22 allows an elastic buffering portion 221 with flange shape to extend to a positioning portion 223, enabling the buffering gasket 22 to be configured with the punching hole 210 of the flange 21 on fan frame 2. The positioning portion 223 is hook up with the punching hole 210 of the flange 21, and the elastic buffering portion 221 is provided with a punching hole 225. While the buffering gasket 22 is penetrated into the punching hole by a fixing component (not shown) and disposed on the supporting member (not shown) like a computer host, the elastic buffering portion 221 of the buffering gasket 22 is clipped and disposed between the flange 21 of the fan frame 2 and the supporting member, thereby absorbing vibration energy by means of the buffering gasket 22.

Although there is a buffering gasket 22 between the flange 21 of fan frame 2 and a supporting member to absorb vibration energy by the elastic buffering portion 221 of buffering gasket 22, yet the wall of the punching hole 210 is still in contact with the fixing component, which is configured with the supporting member of a computer host. That causes that the vibration energy generated is transferred from the wall of the punching hole 210 to the fixing component, and next to the supporting member of the computer host, when the motor on the fan frame 2 is in operation. Therefore, the vibration-proof effect cannot be completely achieved due to the transmission of vibration energy because the punching hole 210 at the flange 21 is still in contact with the fixing component, although the vibration energy is absorbed between the fixing component and the flange of fan frame by means of the elastic buffering portion 221 of buffering gasket 22 for reducing energy transmission.

Moreover, the requirements of a network based server are higher under heat-dissipating conditions, because the operation speed of the network server is far faster than that of a single computer. As operation speed is getting higher heat energy is relatively enhanced. It seems that essential effect of the heat-dissipation cannot be achieved only by a single heat-dissipating fan. In order to reduce heat energy and enhance heat-dissipating performance, the most direct way is to increase the amount of heat-dissipating fans, thereby enhancing heat-dissipating performance by raising the speed and flow rate of airflow. Yet under the conditions of increasing amount of heat-dissipating fans, the vibration energy generated by operating the heat-dissipating fan is relatively enhanced, in this way, that highly influences the hard disk in a high speed operation.

Accordingly, The way of improving the disadvantage from the prior art which fastens the heat-dissipating fan in the computer case and cannot prevent hard disk from being damaged by the vibrations absorbed by vibration-proof component 12 or buffering gasket 22 is eventually an issue to be solved soon for servers, and more particularly for the servers using multi-amount of heat-dissipating devices and relatively enhancing the influence to the hard disk.

### SUMMARY OF THE INVENTION

In order to solve the disadvantage of the conventional apparatus as described above, the main objective of the present invention is to provide a vibration-proof mechanism for use with a heat-dissipating device, thereby reducing the vibrations caused by operating a heat-dissipating device thereof.

Another objective of the present invention is to provide a vibration-proof mechanism for use with a heat-dissipating device, thereby reducing the noises caused by operating a heat-dissipating device thereof.

Further objective of the present invention is to provide a vibration-proof mechanism for use with a heat-dissipating device, which is disposed at both sides of the heat-dissipating device for averagely sharing its weight.

In order to achieve the objective as described above and other objectives, the vibration-proof mechanism for use with a heat-dissipating device in the invention is installed on a machine unit for absorbing vibrations caused by operating a heat-dissipating device thereof, including a plurality of elastic components, a partitioning member connected with one side of the heat-dissipating device by means of elastic components, and a fixing member connected with the partitioning member by elastic components so as to be installed on the machine unit, thereby suspending the partitioning member midair.

A plurality of heat-dissipating fans are installed on the heat-dissipating-device in a shelve body to enhance heat-dissipating performance. The elastic components include a binding member and a vibration-absorptive material, and wherein the binding member is a plug or bolt, and the vibration-absorptive material is a spring or an elastic colloid. The partitioning member is flat and provided with a plurality of punching holes. The vibration-absorptive material is an annular body allowing the binding member to penetrate the vibration-absorptive material and to be disposed into the pinching hole of partitioning member, and enabling the binding member to space the vibration-absorptive material so as to be disposed into the pinching hole of partitioning member. By means of the elastic components which are lined up and disposed at both sides of partitioning member accordingly, a double vibration-proof structure is formed for enhancing vibration absorption.

The fixing member is an L-shaped board or made of an L-shaped board and adjustable plywood, which are disposed at both sides of the heat-dissipating for averagely sharing its weight.

The fixing member is made of the L-shaped board and adjustable plywood. The L-shaped board is pivotally configured with the adjustable plywood. A clipping portion between the L-shaped board and adjustable plywood is provided, which is two semicircle openings disposed accordingly at two sides where one side of L-shaped board and the other side of adjustable plywood are opposite to each other. The elastic components are clipped and installed by the clipping portion. A clipping gap is disposed at one side of the L-shaped board for clipping and installing at the other side of the adjustable plywood, thereby fastening the adjustable plywood. The elastic components are configured with the fixing member made of an L-shaped board and adjustable plywood.

The vibration-proof mechanism for use with a heat-dissipating device in the invention suspends the partitioning member midair by means of the elastic components which are lined up and installed at both sides of partitioning member accordingly to form a double vibration-proof structure. The elastic components include a binding member and a vibration-absorptive material. The transmission of vibration energy may be avoided by the vibration-absorptive material for spacing the punching hole of partitioning member and the binding member. Thereby the effect of vibration-absorption is enhanced, and may further prevent the hard disk in high speed operation from being damaged by vibration energy, and that is more advantageous to use than the prior art.

### BRIEF DESCRIPTION OF DRAWINGS

FIG. 1 is a three-dimensional exploded view of a vibration-proof structure for use with a heat-dissipating fan disclosed in Taiwanese Patent No. M283493;

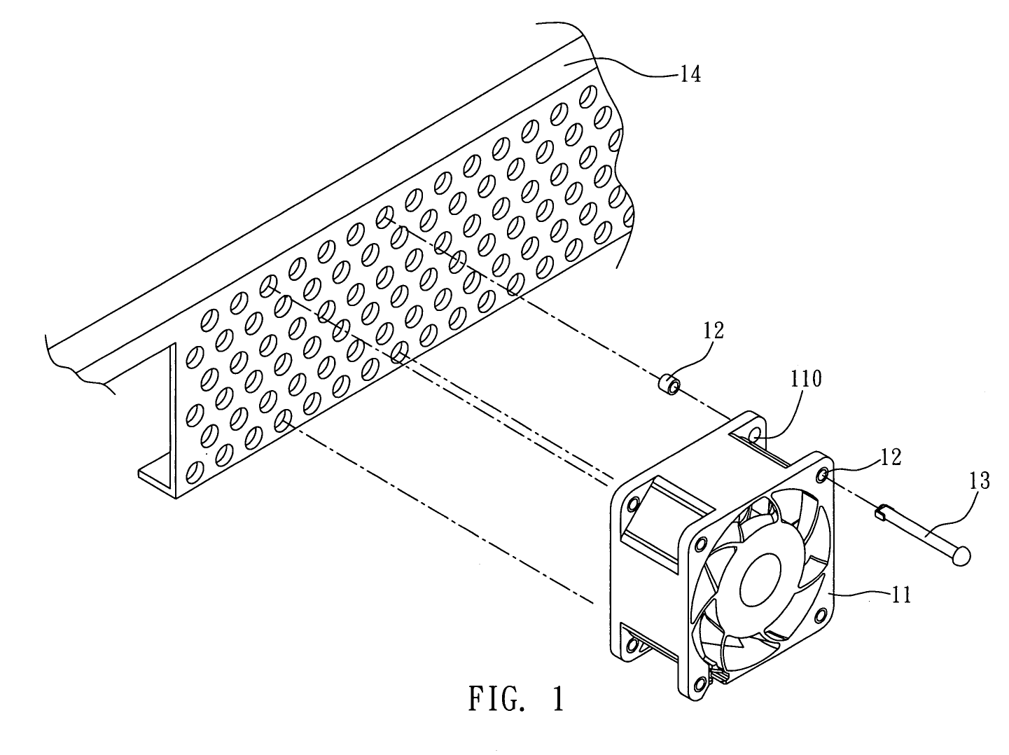

FIG. 2 is a three-dimensional exploded view of an apparatus for installing heat-dissipating fans with a vibration-absorptive structure disclosed in Taiwanese Patent No. 269691;

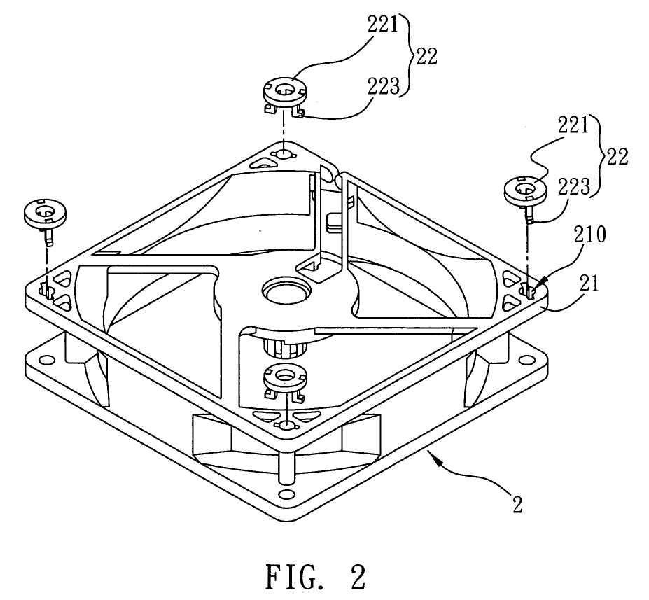

FIG. 3 is a three-dimensional exploded view of a vibration-proof mechanism for use with a heat-dissipating device according to the present invention;

FIG. 4 is an assembly cross-sectional view of the vibration-proof mechanism for use with a heat-dissipating device shown in FIG. 3; and

FIG. 5 is a three-dimensional exploded view of a fixing member in the vibration-proof mechanism for use with a heat-dissipating device in another embodiment of the invention.

### DETAILED DESCRIPTION OF PREFERRED EMBODIMENTS

The invention has been described below by using particular specific embodiments for those skilled in the art to easily have the benefit and effect of the contents disclosed herein.

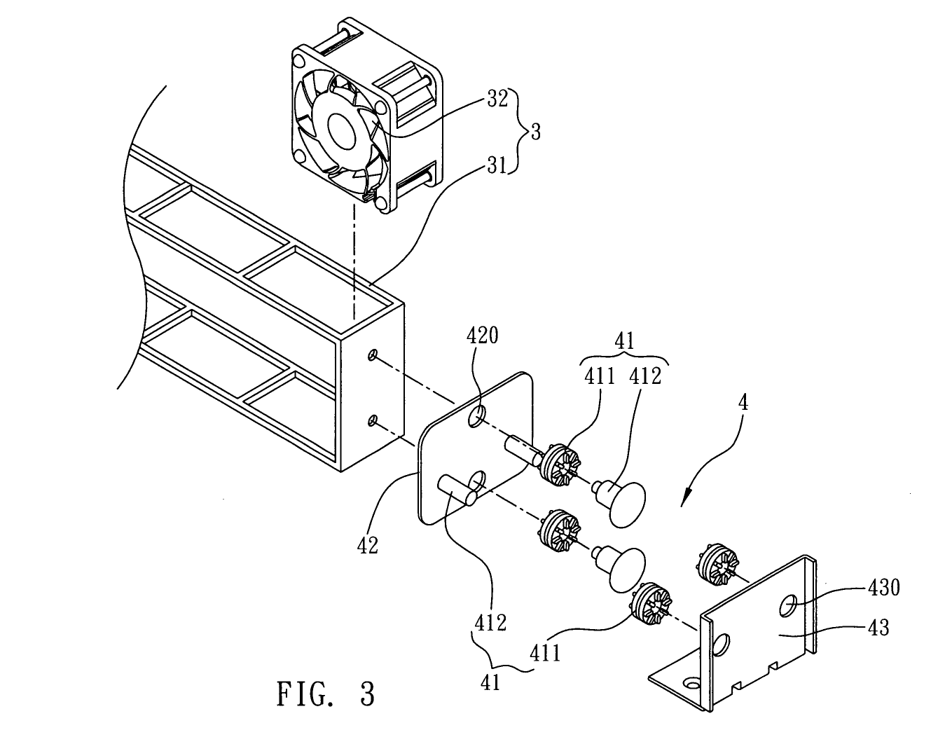

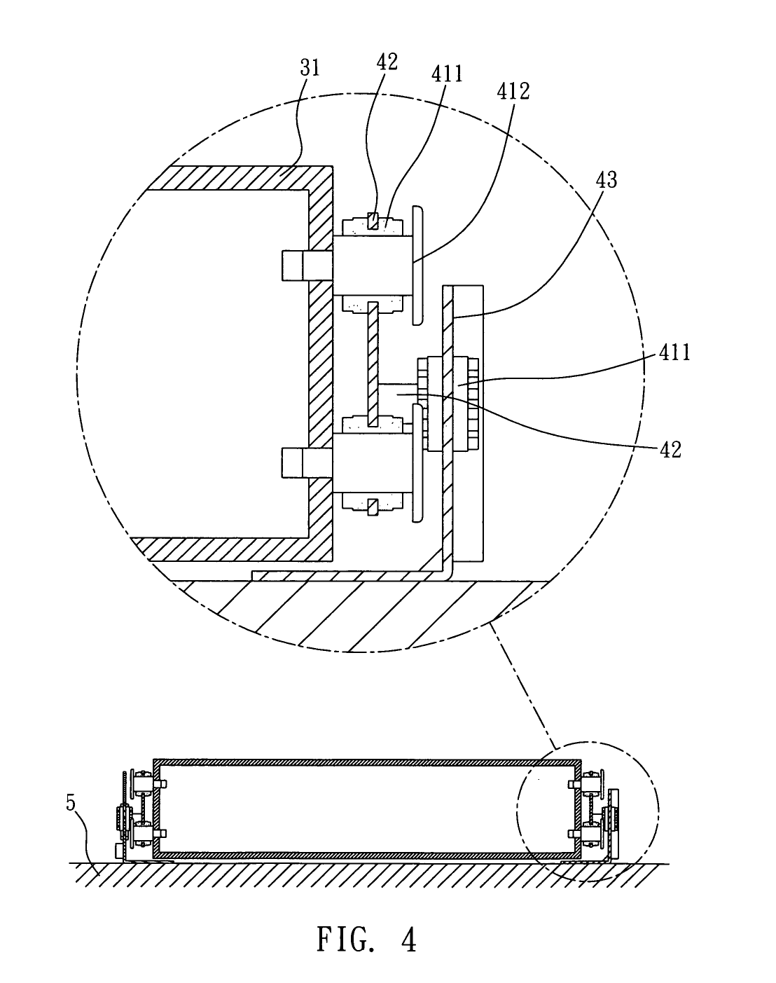

Referring to FIGS. 3 and 4, a three-dimensional exploded view and an assembly cross-sectional view of a vibration-proof mechanism 4 for use with a heat-dissipating device 3 according to the present invention are illustrated. Two vibration-proof mechanisms 4 are installed on both sides of the heat-dissipating device 3. The heat-dissipating device 3 comprises a plurality of heat-dissipating fans 32 disposed in a shelve body 31, and is fastened to a machine unit 5 by the vibration-proof mechanism 4, to absorb vibrations caused by the operating heat-dissipating device 3. The vibration-proof mechanism 4 comprises a partitioning member 42, a fixing member 43, and a plurality of elastic components 41.

Each of the elastic components 41 comprises an annular vibration-absorptive material 411 and a binding member 412. The vibration-absorptive material 411 is a spring or elastic colloid, and the binding member 412 is a plug or bolt.

The partitioning member 42 is flat and is connected with one side of the heat-dissipating device 3 by the elastic components 41. The partitioning member 42 comprises a plurality of punching holes 420. The binding member 412 penetrates the vibration-absorptive material 411 and is disposed in the pinching hole 420 of partitioning member 42. Therefore, the binding member 412 partitions the vibration-absorptive material 411 and is disposed in the pinching hole 420 of the partitioning member 42.

The fixing member 43 is an L-shaped board and is connected with the partitioning member 42 by the elastic components 41, and is installed on the machine unit 5, thereby suspending the partitioning member 42 midair. A punching hole 430 is provided at a vertical side of L-shaped board for the fixing member 43, as to be installed by the elastic components 41. The binding member 412 is penetrated into the vibration-absorptive material 411 and disposed into the punching hole 430 of the fixing member 43, enabling it to space the vibration-absorptive material 411 and to be disposed into the punching hole 430.

The heat-dissipating device 3 is installed on machine unit 5 by the vibration-proof mechanism 4. A plurality of elastic components 41 are lined up and disposed accordingly at both sides of the partitioning member 42 in the vibration-proof mechanism 4. The way of arrangement and the quantity of the elastic components 41 are determined by the operative quantities of the heat-dissipating fans 32 in the heat-dissipating device 3. The elastic components 41 disposed at both sides of the partitioning member 42 are configured with the heat-dissipating device 3 and the fixing member 43 accordingly, to suspend the partitioning member 42 midair and allow the partitioning member 42 to be disposed between the heat-dissipating device 3 and fixing member 43. The heat-dissipating device 3 is suspended and disposed between two fixing members 43, thereby absorbing vibration energy by means of the elastic components 41 when operating, to prevent the hard disk (not shown in drawings) installed on the machine unit 5 from being influenced by the vibrations caused by operating the heat-dissipating device 3 thereof.

The elastic components 41 are also provided for allowing the binding member 412 to penetrate the vibration-absorptive material 411 and to be configured with the punching hole 430 of the fixing member 43, enabling the binding member 412 to space the vibration-absorptive material 411 and to be disposed into the punching hole 430, thereby preventing the binding member 412 from being in contact with the partitioning member 42 and fixing member 43′, in order to avoid that the vibrations caused by operating the heat-dissipating device 3 are transferred to the machine unit 5, and further to prevent the hard disk installed on the machine unit 5 from being influenced by the vibrations caused by operating the heat-dissipating device 3 thereof.

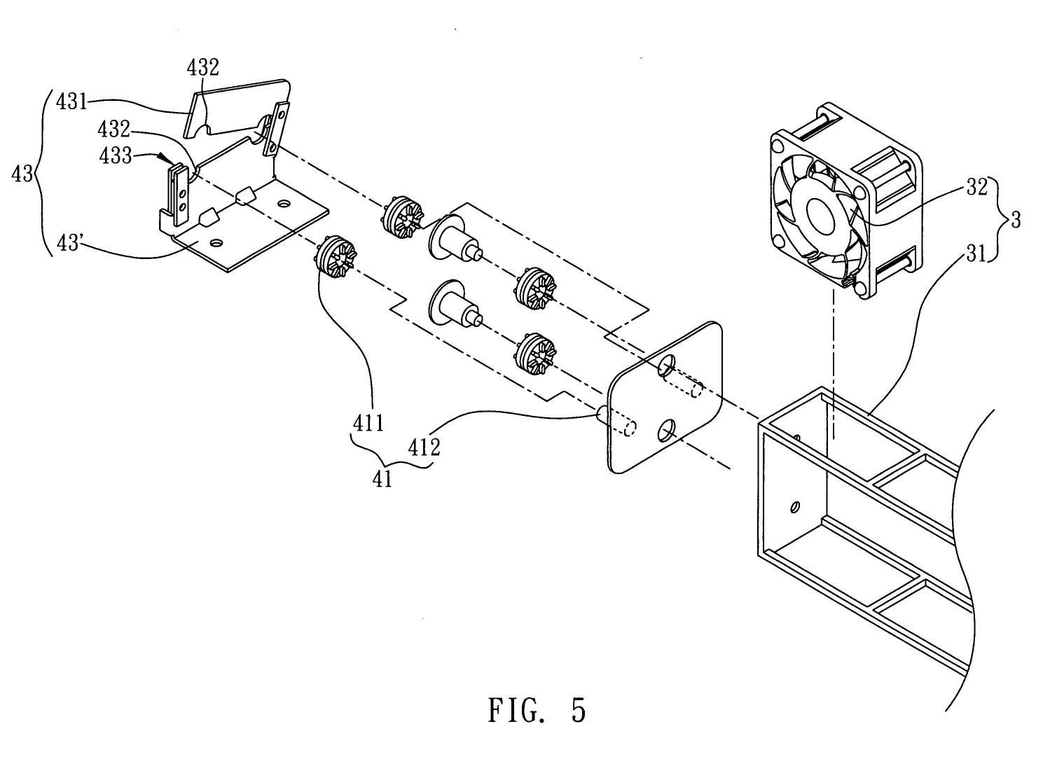

Referring to FIG. 5, another embodiment of the fixing member 43 in the invention is provided. The fixing member 43 is made of an L-shaped board 43′ and a adjustable plywood 431. The vertical side of L-shaped board 43′ is pivotally configured with the adjustable plywood 431. A clipping portion 432 between the L-shaped board 43′ and adjustable plywood 431 is provided, which is two semicircle openings disposed accordingly at two sides where one side of L-shaped board 43′ and the other side of adjustable plywood 431 are opposite to each other. The elastic components 41 are clipped and installed by the clipping portion 432. A clipping gap 433 is disposed at one side of the L-shaped board 43′ for clipping and installing at the side of the adjustable plywood 431, thereby fastening the adjustable plywood 431.

Firstly the adjustable plywood 431 is opened, and then the vibration-absorptive material 411 of elastic components 41 is approached alongside the clipping portion 432 of L-shaped board 43′. Next, the adjustable plywood 431 is pressed to corresponding board side of L-shaped board 43′, and that enables the clipping gap 433 located at one side of the L-shaped board 43′ to be clipped and installed by the board side of adjustable plywood 431. The elastic components 41 are thus clipped by the L-shaped board 43′ and the clipping portion 432, thereby allowing it to be configured with the fixing member 43.

The invention has been described above by using preferred embodiments. However, it is to be understood that the scope of the invention is not limited to the disclosed embodiments. Many equivalent modifications or variations may be made by one of ordinary skill in the art without departing from the spirit and scope of the embodiments above. Accordingly, the scope of the claims as illustrated later should be involved in encompassing all such modifications and variations.

What is claimed is:

1. A vibration-proof mechanism for use with a heat-dissipating device installed on a machine unit, for absorbing vibrations caused by the operating heat-dissipating device, the vibration-proof mechanism comprising:
a plurality of elastic components;
a partitioning member connected with one side of the heat-dissipating device by the elastic components; and
a fixing member connected with the partitioning member by the elastic components and installed on the machine unit, thereby suspending the partitioning member midair.

2. The vibration-proof mechanism of claim 1, wherein the heat-dissipating device comprises a plurality of heat-dissipating fans installed in a shelve body.

3. The vibration-proof mechanism of claim 1, wherein the partitioning member is provided with a plurality of punching holes.

4. The vibration-proof mechanism of claim 1, wherein at least one of the elastic components comprises a binding member and a vibration-absorptive material.

5. The vibration-proof mechanism of claim 4, wherein the vibration-absorptive material is an annular body allowing the binding member to penetrate the vibration-absorptive material and to be disposed into the pinching hole of partitioning member, and enabling the binding member to space the vibration-absorptive material so as to be disposed into the pinching hole of partitioning member.

6. The vibration-proof mechanism of claim 4, wherein the binding member is one of a plug and a bolt.

7. The vibration-proof mechanism of claim 4, wherein the vibration-absorptive material is one of a spring and an elastic colloid.

8. The vibration-proof mechanism of claim 1, wherein the partitioning member is flat.

9. The vibration-proof mechanism of claim 1, wherein the fixing member is an L-shaped board, and a punching hole is provided at a vertical side of L-shaped board for the fixing member, as to be installed by the elastic components.

10. The vibration-proof mechanism of claim 1, wherein the fixing member is made of an L-shaped board, an adjustable plywood pivotally installed on a vertical side of the L-shaped board, and a clipping portion installed between the L-shaped board and the adjustable plywood for clipping the elastic components.

11. The vibration-proof mechanism of claim 10, wherein the clipping portion comprises two semicircle openings disposed respectively at two sides where one side of L-shaped board and the other side of the adjustable plywood are opposite to each other.

12. The vibration-proof mechanism of claim 10 further comprising a clipping gap disposed at one side of the L-shaped board for being clipped and installed at the other side of the adjustable plywood, and for fastening the adjustable plywood.
